(19) United States
(12) Patent Application Publication
(10) Pub. No.: US 2008/0253861 A1
(43) Pub. Date: Oct. 16, 2008

(54) Method and unit for shipping a torque limiting assembly

(75) Inventors: Yoshiki Tada, Okazaki-city (JP); Michiyasu Nosaka, Anjo-city (JP); Shoji Kageyama, Kariya-city (JP); Hiromasa Tanaka, Ichinomiya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/078,964

(22) Filed: Apr. 8, 2008

(30) Foreign Application Priority Data
Apr. 13, 2007 (JP) 2007-105684

(51) Int. Cl. F16B 35/00; B65B 29/00

(52) U.S. Cl. 411/392; 53/397

(57) ABSTRACT

A method for shipping a torque limiting assembly comprises the steps of preparing a male member fitted with an internal thread of the torque limiting assembly, coating the male member with grease, fitting the male member into the internal thread of the torque limiting assembly, and shipping the torque limiting assembly. A unit for shipping a torque limiting assembly comprises the torque limiting assembly and the male member which is fitted with the internal thread of the torque limiting assembly, coating the male member with grease.

### BACKGROUND OF THE INVENTION

1. Field of the Invention

This invention relates to a method and unit for shipping a torque limiting assembly for transmitting driving power from a wheel driven by an external drive source, to an input shaft of a driven device.

2. Description of the Related Art

Generally, a compressor for a car air-conditioner is driven by an external power source such as an engine through a belt, a pulley, etc. A torque limiting assembly in case of excessive load torque of the compressor is located between an input shaft of the compressor and the external power.

For example, a power transmission device 11 including the torque limiting assembly is known as shown in FIG. 7. Power transmission device 11 includes part of compressor housing 13. A pulley 17 is rotationally arranged on housing 13 through a bearing 15 and housing 13 has an input shaft 19 which is supported on a journal thereof. Input shaft 19 includes a small-diameter portion 23 on a front-side, a large-diameter portion 25 on a rear-side, and a stepped portion 27 is formed between small-diameter portion 21 and large-diameter portion 25. An external thread 21 is formed in small-diameter portion 23.

A compressor unit 20 includes housing 13, bearing 15, pulley 17 and input shaft 19. Stepped portion 27 of input shaft 19 is fitted with an annular washer 29. Annular washer 29 is also fitted inside an annular hub 31.

Hub 31 includes an inner hub 33, an annular cylindrical portion 35, a cylindrical outer ring 37, and an engaging portion 39. Inner hub 33 is fitted with washer 29. Annular cylindrical portion 35 consisting of an elastic material, such as rubber, is formed on the outer periphery of inner hub 33. A cylindrical outer ring 37 is arranged on the outer periphery of cylindrical portion 35. Engaging portion 39 is formed on the outer periphery of outer ring 37 and is engaged with an engaging portion 17a of pulley 17.

On the other hand, external thread 21 of input shaft 19 is screwed to an internal thread 43 of a power interruption member 41. Power interruption member 41 includes a cylindrical portion 45, a flange portion 47, and a breaking portion 49. Cylindrical portion 45 has the internal thread 43 on the inner periphery thereof screwed to external thread 21. Flange portion 47 is increased in diameter outward from the front side of cylindrical portion 45. Breaking portion 49 is formed between cylindrical portion 45 and flange portion 47.

Power interruption member 41 is screwed on external thread 21, and inner hub 33 is pressed against washer 29 by flange portion 47, so that hub 31 can be fixedly pressed against stepped portion 27 through washer 29. A hole 51 is formed at the front-side central portion of the power interruption member 41 and the hole 51 communicates with the inner periphery of the cylindrical portion 45. A resin cap 53 is fitted under pressure in the hole 51 in order to prevent intrusion of foreign matter, for example dust and dirt, water, etc. into the internal thread 43.

The hub 31 and the power interruption member 41 make up a torque limiting assembly 55.

Under normal operation, the rotational torque from the pulley 17 is transmitted to the hub 31 through the engaging portion 17a of the pulley 17 and the engaging portion 39 of the hub 31, which are engaged with each other. In order to drive the compressor, the torque transmitted to the hub 31 is transmitted to the input shaft 19 of the compressor through the washer 29, which is interposed between the inner hub 33 and the stepped portion 27.

In the case that the input shaft is locked due to a malfunction of a compressor such as burning, excessive torque is generated between the input shaft 19 and the hub 31. This excessive torque causes slippage between the washer 29 and the stepped portion 27, thereby causing rotation between the internal thread 43 and the external thread 21. This rotation causes the cylindrical portion 45 to be screwed inside the inner hub 33 toward the large-diameter portion 25. By this inward movement, a large amount of force is applied to the cylindrical portion 45 in the direction away from the flange portion 47, thereby breaking the breaking portion 49. This breakage eliminates the force of the power interruption member 41 to press the inner hub 33 against the washer 29, and excessive torque transmission from the hub 33 to the input shaft 19 is interrupted.

In this type of the power transmission device 11, an operation failure may be caused by intrusion of water, dust and dirt, etc. between the external thread 21 and the internal thread 43. Therefore, seal means are provided to protect the threaded portions.

For example, a power interruption mechanism using the screw fitting as described above, is disclosed in Japanese Unexamined Patent Publication No. 2003-206950.

Furthermore, the threshold torque for the power interruption changes depending on the friction coefficient between the external thread 21 and the internal thread. Therefore, the management of the friction coefficient is very important to improve the accuracy of the threshold torque. For this reason, in the conventional power transmission device 11, the threaded portions are greased to maintain a constant friction coefficient.

Recently, there is an increasing demand to assemble power transmission device 11 with a compressor unit 20 and a torque limiting assembly 55, which are separately fabricated, or purchased. In this case, the grease has to be applied to the threaded portions when assembling them. Therefore, it is difficult to manage to decide a position and amount of grease.

When grease is applied to internal thread 43 of the power interruption member 41 before shipment, the grease may be rubbed off or the threaded portions may become fouled with dust or dirt before assembly of the two threaded portions.

For example, in Japanese Unexamined Patent Publication No. 2006-153258, a seal member is disclosed, which is used to prevent foreign matter from intruding into the threaded portions.

### SUMMARY OF THE INVENTION

The object of this invention is to solve the above described problem and provide a method and unit of shipping a torque limiting assembly including a hub and a power interruption member, wherein means for stabilizing the friction coefficient between an internal thread of the power interruption member and an external thread of an input shaft, can be supplied between the internal and external threads.

In order to solve the above described problem, according to a first aspect of the invention, there is provided a method for shipping a torque limiting assembly, wherein the torque limiting assembly includes
an annular hub having
   a washer in contact with a larger diameter portion of an input shaft at a stepped portion, wherein the input shaft is projected from a housing of a driven device and the larger diameter portion is formed on a rear-side of the input shaft, and
   an outer peripheral portion engaging a wheel rotationally driven by a drive source; and
a cylindrical power interruption member including
   an internal thread screwed with an external thread formed on the front-side of the input shaft and
   a flange portion engaging the front-side inner peripheral portion of the annular hub;
the method comprising the steps of:
preparing a male member fitted with the internal thread of the power interruption member;
coating the male member with means for stabilizing the friction coefficient between the internal thread of the power interruption member and the external thread of the input shaft;
fitting the male member coated with the means into the internal thread of the power interruption member; and
shipping the torque limiting assembly.

According to another aspect of the invention, there is provided a unit for shipping a torque limiting assembly, the unit comprising the torque limiting assembly and a male member:
the torque limiting assembly including
an annular hub having
   a washer in contact with a larger diameter portion of an input shaft at a stepped portion, wherein the input shaft is projected from a housing of a driven device and the larger diameter portion is formed on a rear-side of the input shaft,
   an outer peripheral portion engaging a wheel rotationally driven by a drive source; and
a cylindrical power interruption member including
   an internal thread screwed with an external thread formed on the front-side of the input shaft and
   a flange portion engaging the front-side inner peripheral portion of the annular hub;
wherein the male member is fitted with the internal thread of the power interruption member, being coated with means for stabilizing the friction coefficient between the internal thread of the power interruption member and the external thread of the input shaft.

By screwing the internal and external threads to each other during assembly, the means for stabilizing the friction coefficient between the internal thread and the male member of the power interruption member, can be securely held. As a result, a reliable torque limiting operation can be performed, even if a power transmission device is assembled with a compressor unit and a torque limiting assembly, which are separately fabricated.

In order to solve the problem described above, according to another aspect of the invention, the male member can have an external thread in the outer periphery. Therefore, a bolt or the like can be used for reduced cost.

In order to solve the problem described above, according to another aspect of the invention, the male member can have a multiplicity of axially extending grooves in the outer periphery. Therefore, the friction coefficient stabilization means can be sufficiently held in the multiplicity of the grooves, and the power interrupt operation can be securely performed.

In order to solve the problem described above, according to a further aspect of the invention, the male member can be made of a flexible material. Therefore, the friction coefficient stabilization means can be held more securely.

The present invention may be more fully understood from the description of preferred embodiments of the invention, as set forth below, together with the accompanying drawings.

### BRIEF DESCRIPTION OF THE DRAWINGS

FIG. 1 is a longitudinal sectional view showing a unit for shipping a torque limiting assembly according to a first embodiment of the invention.

FIG. 2 is a longitudinal sectional view showing a method for shipping a torque limiting assembly shown in FIG. 1.

FIG. 3 is a longitudinal sectional view showing the essential parts of a unit for shipping a torque limiting assembly according to a second embodiment of the invention.

FIG. 4 is a longitudinal sectional view showing the essential parts of a unit for shipping a torque limiting assembly according to a third embodiment of the invention.

FIG. 5 is a longitudinal sectional view showing the essential parts of a unit for shipping a torque limiting assembly according to a fourth embodiment of the invention.

FIG. 6 is a longitudinal sectional view showing the essential parts of the unit for shipping a torque limiting assembly according to a fifth embodiment of the invention.

FIG. 7 is a longitudinal sectional view showing a power transmission device assembled using a unit for shipping a torque limiting assembly.

### DESCRIPTION OF THE PREFERRED EMBODIMENTS

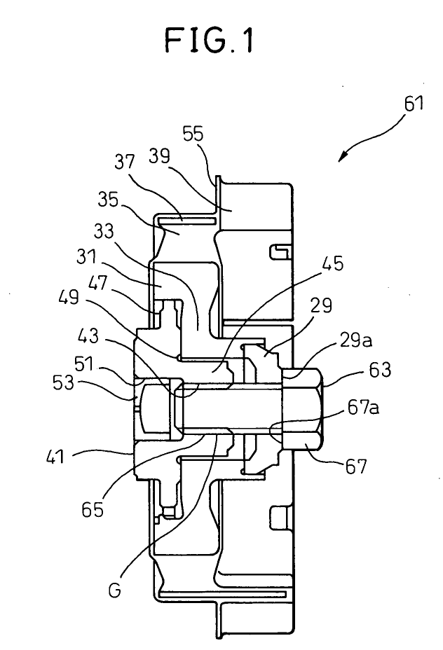

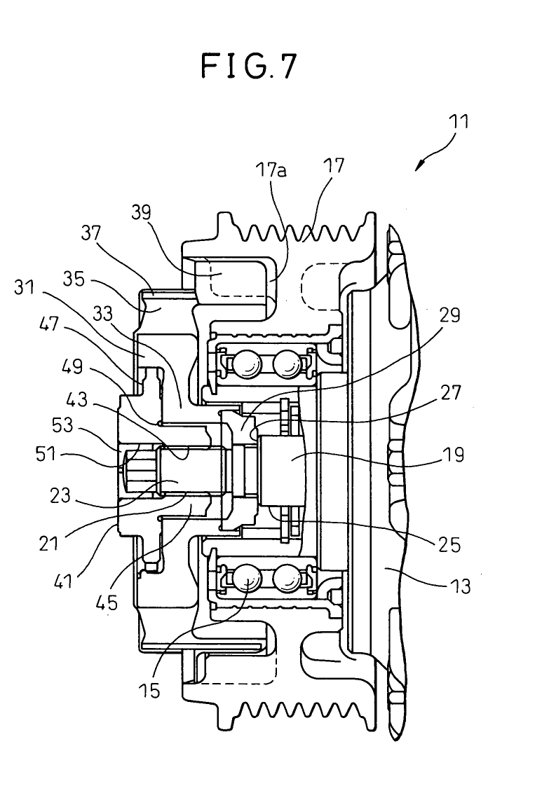

The embodiments of the invention will be explained below with reference to FIGS. 1 to 6. In the drawings, the component parts having the same configuration as in the related art shown in FIG. 7 are designated by the same reference numerals, respectively, and will not be described hereafter.

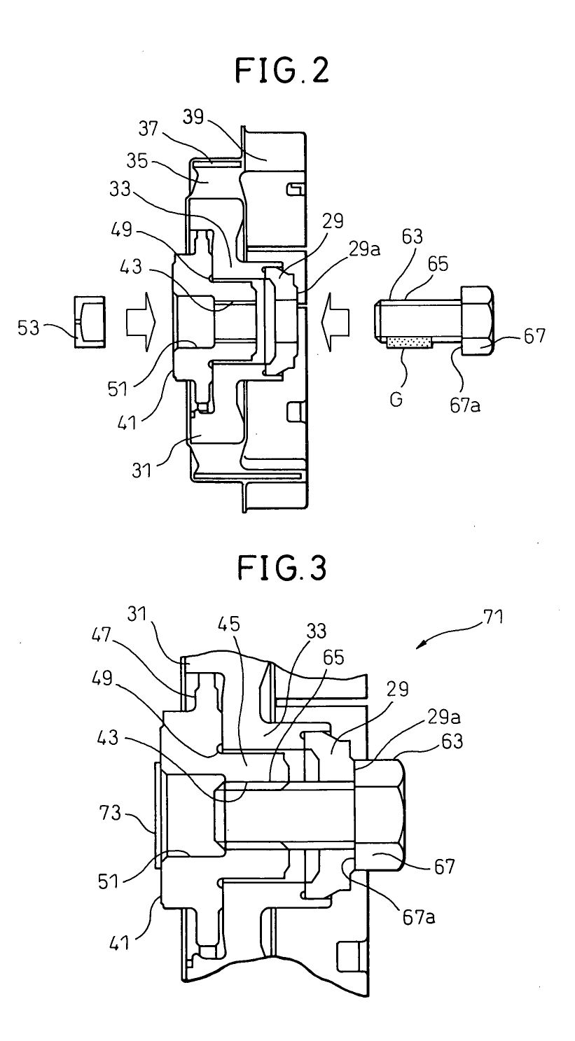

FIGS. 1 and 2 show a unit for shipping a torque limiting assembly 61 according to a first embodiment of the invention.

The unit for shipping a torque limiting assembly 61 includes a torque limiting assembly 55 with a washer 29, a cap 53 and a bolt 63 coated with grease. In torque limiting assembly 55, a cylindrical portion 45 of a power interruption member 41 is inserted into the inner peripheral surface of a hub 31 and has a flange portion 47 arranged in contact with the front-side end surface of hub 31. Washer 29 is fitted into the rear-side inner peripheral surface of hub 31. Bolt 63 includes an external thread 65 and a head portion 67 larger in diameter than externally threaded 65. A predetermined amount of grease G is coated at a predetermined position on the outer peripheral surface of external thread 65. External thread 65 of bolt 63 coated with grease G, as shown in FIG. 2, is forcibly screwed into internal thread 43 of power interruption member 41. In the process, the grease on external thread 65 is coated uniformly over internal thread 43 of power interruption member 41. Seat surface 67a of head portion 67 of bolt 63 is in contact with rear-side seat surface 29a of washer 29, thereby integrally fixing hub 31, power interruption member 41 and washer 29. A cap 53, which is used to prevent the intrusion of foreign matter or the like, is fitted in front-side hole 51 of power interruption member 41.

The unit for shipping torque limiting assembly 61 is shipped under the above condition.

In order to assemble the unit with compressor unit 20, bolt 63 is removed from the unit for shipping torque limiting assembly 61. In the process, internal thread 43 of power interruption member 41 is uniformly coated with the grease.

Then, internal thread 43 of power interruption member 41 is forcibly screwed onto external thread 21 of input shaft 19 of compressor unit 20 and fastened with a predetermined torque. Under this condition, hub 31 and washer 29 are fixedly pressed against input shaft 19 by flange portion 47 of power interruption member 41. The grease coated on internal thread 43 of power interruption member 41 is also coated on external thread 21 of input shaft 19, so that the friction coefficient between the internal and external threads can be maintained at a proper value.

As explained above, the unit for shipping a torque limiting assembly 61 includes torque limiting assembly 55 and external thread 65, wherein external thread 65, being coated with grease G, is screwed to internal thread 43 of power interruption member 41.

In a method for shipping a torque limiting assembly, after a bolt 63 is coated with grease G, external thread 65 is fitted into internal thread 43 of power interruption member 41. Under this condition, torque limiting assembly 55 is shipped.

Since grease G can be held between internal thread 43 of power interruption member 41 and external thread 65 of bolt 63, the grease can be kept coated in a predetermined state on internal thread 43, when compressor unit 20 is assembled with torque limiting assembly 55.

Furthermore, internal thread 43 of power interruption member 41 is not required to be exposed before the assembly. Therefore, the threads can be protected against damage, while at the same time preventing the intrusion of foreign matter into the threaded surface.

Since surface 67a of head portion 67 of bolt 63 is kept in contact with rear-side surface 29a of washer 29, rear-side surface 29a can be protected against intrusion of foreign matter.

Accordingly, when torque limiting assembly 55 is assembled with compressor unit 20, the assembly is efficiently improved. At the same time, it is possible to distribute torque limiting assembly 55 without a compressor unit as a single product.

FIG. 3 shows the essential parts of a unit for shipping a torque limiting assembly 71 according to a second embodiment of the invention. This unit for shipping a torque limiting assembly 71 is similar to the unit for shipping torque limiting assembly 61 of the first embodiment shown in FIGS. 1 and 2, except that a protective seal 73 is used instead of cap 53 of FIGS. 1 and 2. Protective seal 73 prevents the intrusion of foreign matter or the like into the threaded portions.

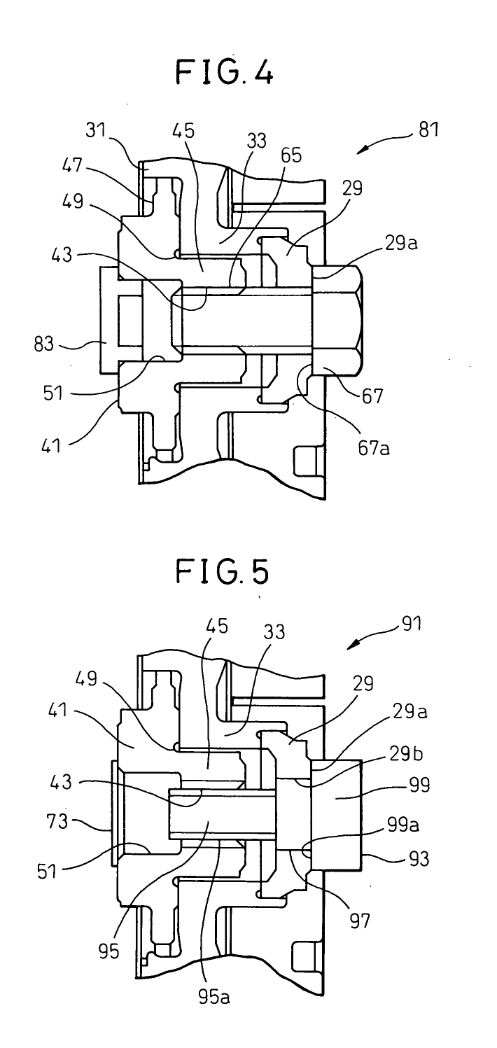

FIG. 4 shows the essential parts of a unit for shipping a torque limiting assembly 81 according to a third embodiment of the invention. This unit for shipping torque limiting assembly 81 is similar to the unit for shipping torque limiting assembly 61 of the first embodiment shown in FIGS. 1 and 2, except that cap 53 is replaced with another cap 83. Cap 83 is used only at the time of transporting the unit for shipping torque limiting assembly 81. Cap 83 can also prevent the intrusion of foreign matter or the like into the threaded portions.

FIG. 5 shows the essential parts of a unit for shipping a torque limiting assembly 91 according to a fourth embodiment of the invention. This unit for shipping torque limiting assembly 91 includes a plug 93 in place of bolt 63 shown in FIGS. 1 and 2.

Plug 93 includes a male member 95, a pressure-fitting portion 97 and a head portion 99. Male member 95 is fitted into internal thread 43 of power interruption member 41 and has a multiplicity of grooves 95a axially formed on the outer peripheral surface thereof to hold the grease. Pressure-fitting portion 97 is larger in diameter than male member 95 and is fitted under pressure on inner peripheral surface 29b of washer 29. Head portion 99 is larger in diameter than pressure-fitting portion 97 and has a surface 99a in contact with rear-side surface 29a of washer 29.

Male member 95 of plug 93 with the grease coated in grooves 95a is fitted into internal thread 43 of power interruption member 41. Pressure-fitting portion 97 is fitted under pressure into inner peripheral surface 29b of washer 29. Surface 99a of head portion 99 is mounted in contact with rear-side surface 29a of washer 29.

Therefore, the grease is coated between male member 95 and internal thread 43. Plug 93 is prevented from falling out by pressure-fitting portion 97. Rear-side surface 29a of washer 29 is protected by surface 99a of head portion 99.

Protective seal 73 as shown in FIG. 3 is arranged in front-side hole 51 of power interruption member 41 in order to prevent the intrusion of foreign matter or the like.

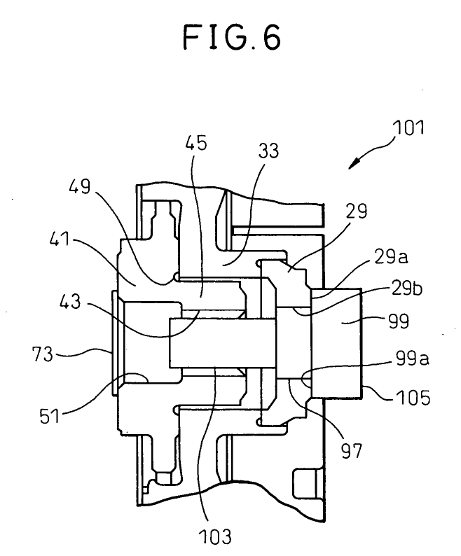

FIG. 6 shows the essential parts of a unit for shipping a torque limiting assembly 101 according to a fifth embodiment of the invention. This unit for shipping a torque limiting assembly 101 includes a male member 103 made of a flexible material for holding the grease, in place of male member 95 of the unit for shipping torque limiting assembly 91 as shown in FIG. 5. The other parts are similar to the corresponding parts of the unit for shipping torque limiting assembly 91. A soft material such as sponge or resin is used as the flexible material of male member 103. In plug 105, male member 103 containing the grease is inserted into internal thread 43 of power interruption member 41 thereby coating the grease on internal thread 43.

While the invention has been described by reference to specific embodiments chosen for purposes of illustration, it should be apparent that numerous modifications could be made thereto by those skilled in the art without departing from the basic concept and scope of the invention.

1. A method for shipping a torque limiting assembly,
wherein the torque limiting assembly includes
an annular hub having
a washer in contact with a larger diameter portion of an input shaft at a stepped portion, wherein the input shaft is projected from a housing of a driven device and the larger diameter portion is formed on a rear-side of the input shaft, and
an outer peripheral portion engaging a wheel rotationally driven by a drive source; and
a cylindrical power interruption member including
an internal thread screwed with an external thread formed on the front-side of the input shaft and
a flange portion engaging the front-side inner peripheral portion of the annular hub;
the method comprising the steps of:
preparing a male member fitted with the internal thread of the power interruption member;
coating the male member with means for stabilizing the friction coefficient between the internal thread of the power interruption member and the external thread of the input shaft;
fitting the male member coated with the means into the internal thread of the power interruption member; and
shipping the torque limiting assembly.

2. The method of shipping the torque limiting assembly according to claim 1,
wherein the male member has an external thread formed on the outer periphery thereof.

3. The method of shipping the torque limiting assembly according to claim 1,
wherein the male member has a multiplicity of grooves extended axially on the outer periphery thereof.

4. The method of shipping the torque limiting assembly according to claim 1,
wherein the male member is made of a flexible material.

5. A unit for shipping a torque limiting assembly, the unit comprising the torque limiting assembly and a male member:
the torque limiting assembly including
an annular hub having
a washer in contact with a larger diameter portion of an input shaft at a stepped portion, wherein the input shaft is projected from a housing of a driven device and the larger diameter portion is formed on a rear-side of the input shaft,
an outer peripheral portion engaging a wheel rotationally driven by a drive source; and
a cylindrical power interruption member including
an internal thread screwed with an external thread formed on the front-side of the input shaft and
a flange portion engaging the front-side inner peripheral portion of the annular hub;
wherein the male member is fitted with the internal thread of the power interruption member, being coated with means for stabilizing the friction coefficient between the internal thread of the power interruption member and the external thread of the input shaft.

6. The unit for shipping a torque limiting assembly according to claim 5,
wherein the male member is formed with an external thread formed on the outer periphery thereof.

7. The unit for shipping a torque limiting assembly according to claim 5,
wherein the male member has a multiplicity of grooves extended axially on the outer periphery thereof.

8. The unit for shipping a torque limiting assembly according to claim 5,
wherein the male member is formed of a flexible material.
